(19) United States
(12) Patent Application Publication
(10) Pub. No.: US 2005/0252734 A1
(43) Pub. Date: Nov. 17, 2005

(54) Electromechanical brake pressure generator for a motor vehicle brake system and motor vehicle brake system

(75) Inventor: Wilfried Giering, Mendig (DE)

Correspondence Address: MACMILLAN, SOBANSKI & TODD, LLC, ONE MARITIME PLAZA - FOURTH FLOOR, 720 WATER STREET, TOLEDO, OH, 43604, US

(73) Assignee: Lucas Automotive GmbH

(21) Appl. No.: 11/130,319

(22) Filed: May 16, 2005

(30) Foreign Application Priority Data
May 17, 2004 (DE) 10 2004 024 403.0

(51) Int. Cl. F16D 55/08

(52) U.S. Cl. 188/72.8

(57) ABSTRACT

In an electromechanical brake pressure generator for a motor vehicle brake system comprising a force input element, which is connected to a brake pedal, a housing and a pressure piston displaceable in the housing, wherein the pressure piston with the housing encloses a pressure chamber for generating a hydraulic brake pressure, and a threaded spindle/threaded nut arrangement, of which one component for displacing the pressure piston is guided linearly relative to the housing by means of an anti-rotation device and of which the other component is settable in rotation in the housing, wherein the pressure piston is displaceable in accordance with a displacement of the force input element by virtue of the setting in rotation of the component of the threaded spindle/threaded nut arrangement that is settable in rotation in order to generate a hydraulic brake pressure in the pressure chamber, in order to improve the anti-rotation device it is provided that a region of the linearly guided component of the threaded spindle/threaded nut arrangement is provided with a cylindrical guide profile, which interacts with a complementary profile that is fixed relative to the housing, wherein the area of the guide profile has such a shape that the linearly guided component of the threaded spindle/threaded nut arrangement is supported against the complementary profile during a transmission of supporting forces that is uniformly distributed over the periphery of the cylindrical guide profile.

The present invention relates to an electromechanical brake pressure generator for a motor vehicle brake system comprising a force input element, which is connected to a brake pedal, a housing and a pressure piston displaceable in the housing, wherein the pressure piston with the housing encloses a pressure chamber for generating a hydraulic brake pressure, and a threaded spindle/threaded nut arrangement, one component of which for displacing the pressure piston is guided linearly relative to the housing by means of an anti-rotation device and the other component of which is settable in rotation in the housing, wherein the pressure piston is displaceable in accordance with a displacement of the force input element by virtue of the setting in rotation of the component of the threaded spindle/threaded nut arrangement that is settable in rotation in order to generate a hydraulic brake pressure in the pressure chamber.

Such an electromechanical brake force generator is known, for example, from U.S. Pat. No. 4,918,921. In this brake force generator, an electric motor is activated in accordance with an actuation of a brake pedal. The rotor of the electric motor is in said case connected non-rotatably to the threaded nut of a ball screw. The threaded spindle of the ball screw is received in the threaded nut and locked against rotation in the housing, but is displaceable linearly upon a rotation of the threaded nut. It is therefore possible to displace a brake piston for generating a brake pressure inside the housing by virtue of a linear displacement of the threaded spindle. In the arrangement known from the background art, the spindle at its end remote from the pressure piston is designed with a unilaterally flattened, cylindrical guide profile, which is guided and locked against rotation in a corresponding guide opening in the housing. In this way, it is admittedly possible to achieve linear guidance of the spindle. However, the fact that the supporting forces, which in this background art are transmitted from the threaded spindle to the housing only via the flattened region of the guide profile, are distributed unevenly over the periphery of the guide profile leads to impaired functioning of the arrangement. This is attributable in particular to wear effects, which are distributed uniformly over the periphery of the guide profile, and to locally occurring wedging effects.

A similar arrangement is known from U.S. Pat. No. 4,653,815. In this brake force generator, the threaded nut is set in rotation via external gearing by means of an electric motor. In this arrangement too, the threaded spindle is guided linearly and locked against rotation in the housing, wherein the anti-rotation device is realized by means of a guide pin, which penetrates one end of the threaded spindle and is received in axial grooves in the housing.

From DE 102 55 198 A1 an electromechanical brake pressure generator is known, in which the threaded spindle is received and locked against rotation in the housing.

Finally, from DE 30 31 643 C2 an electromechanical brake pressure generator is known, in which the support is effected by means of a clutch arrangement.

Against this background, an object of the present invention is to provide an electromechanical brake pressure generator of the initially described type, in which the anti-rotation device enables a trouble-free and low-friction linear motion.

This object is achieved by an electromechanical brake pressure generator having the features of the preamble of claim 1 in that, for forming the anti-rotation device, a region of the linearly guided component of the threaded spindle/threaded nut arrangement is provided with a cylindrical guide profile, which interacts with a complementary profile that is fixed relative to the housing, wherein the area of the guide profile has such a shape that the linearly guided component of the threaded spindle/threaded nut arrangement is supported against the complementary profile during a transmission of supporting forces that is uniformly distributed over the periphery of the cylindrical guide profile.

By virtue of such a design of the cylindrical guide profile and the complementary profile it is guaranteed that no lumped loads occur during transmission of the supporting forces, with the result that the linearly guided component of the threaded spindle/threaded nut arrangement is subject neither to locally restricted wear nor to a wedging phenomenon and is therefore reliably guided linearly relative to the housing and has a long life.

When in the context of the description and the claims of the present invention there is mention of a “brake pressure generator”, this expression is intended to include both an arrangement, in which a fluid pressure is generated in the pressure chamber by means of a brake pedal and a master brake cylinder connected thereto, and an arrangement, in which a brake pedal actuation is sensed and in accordance therewith, without directly utilizing the pedal actuating force exerted on the brake pedal, a fluid pressure is then generated in the pressure chamber. The expression “brake pressure generator” is further intended to include also arrangements that utilize the pedal actuating force, which is exerted on the brake pedal, only partially or only in specific (emergency) operating situations.

According to an advantageous development of the invention, the above advantages are in particular also achievable by the guide profile having a polygonal area. By designing the guide profile with a polygonal area, in particular with a regular polygonal area, supporting forces may be transmitted via the individual sides of the polygon such that as they are distributed evenly over the periphery, without locally occurring peak values leading to increased local wear or even to jamming of the linear guide. According to a constructional variant, it is provided that the guide profile has a substantially triangular area. It may further be provided that the side edges of the polygonal area are of an arc-shaped design. The tendency to jam and undesirable wear effects may be overcome even more effectively when the corner regions of the polygonal area are continuously rounded.

To simplify manufacture of the brake pressure generator according to the invention, a development of the invention provides that the complementary profile is formed by a guide ring, which positively receives the guide profile at least in sections. Thus, the guide ring may be manufactured, for example, from a sheet-metal element that is fitted later in the housing. If the complementary profile positively receives the guide profile only in sections, then in the regions where there is no positive abutment there is the possibility of accommodating lubricant that, where necessary, is drawn by capillary action into the mutually adjacent regions.

A development of the invention provides that the guide ring is accommodated non-rotatably in the housing. This may be effected, for example, by glueing, welding or pinching, in particular by means of edge connections.

According to the invention, it may further be provided that the guide ring is manufactured from a friction-reducing material or is coated with a friction-reducing material, preferably with polytetrafluoroethylene. In this way, with a low technical outlay a further perceptible improvement of the guide properties and a further reduction of the wear effects may be achieved.

In a preferred form of construction of the invention, it is provided that the linearly guided component of the threaded spindle/threaded nut arrangement is formed by the threaded spindle and that the component of the threaded spindle/threaded nut arrangement that is settable in rotation is formed by the threaded nut. A further reduction of friction may be achieved when the threaded spindle/threaded nut arrangement is formed by a ball screw.

The invention further relates to a motor vehicle brake system having an electromechanical brake pressure generator of the previously described type.

The invention is described below by way of example with reference to the accompanying drawings. The drawings show:

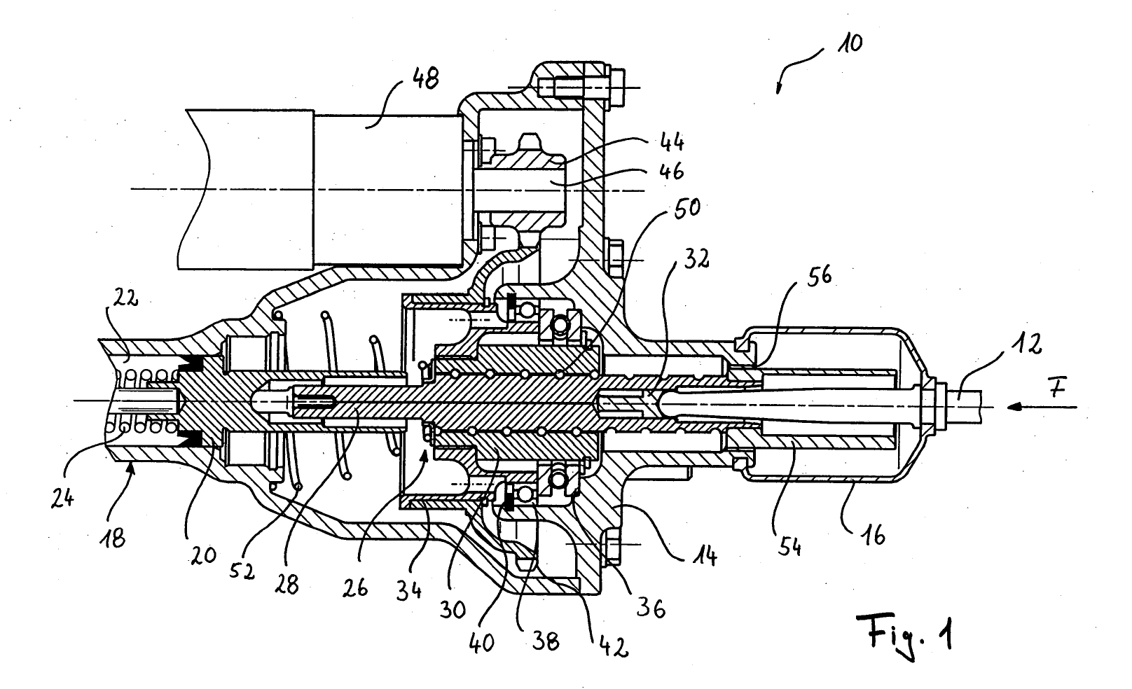

FIG. 1 a longitudinal sectional partial view of a brake pressure generator according to the invention;

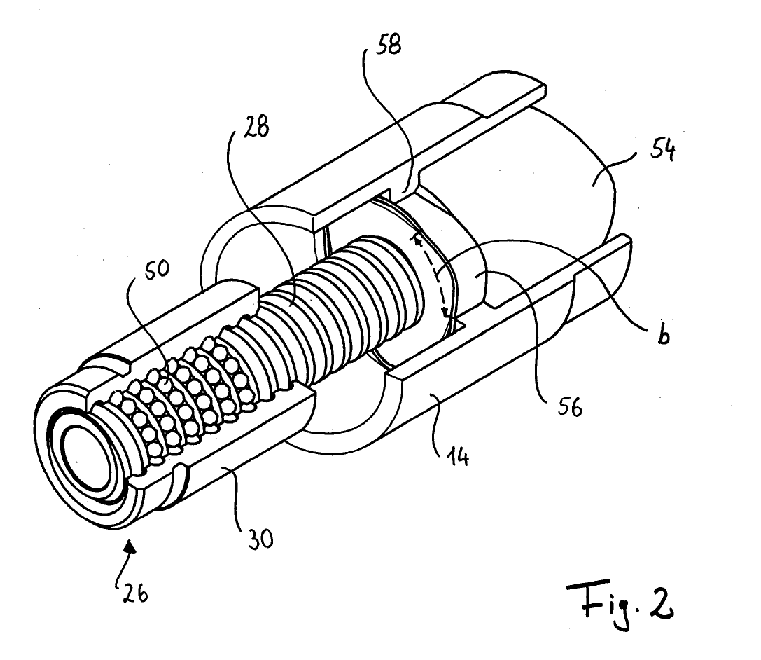

FIG. 2 a perspective view of individual components of the brake pressure generator according to the invention;

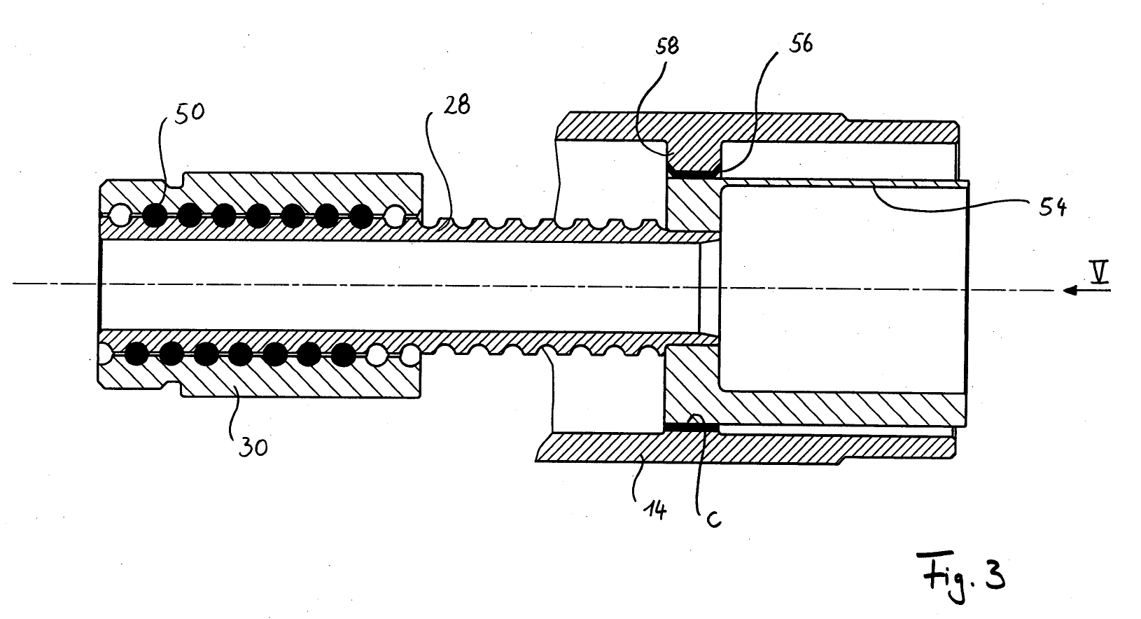

FIG. 3 a view of the components according to FIG. 2 in a longitudinal sectional view; and

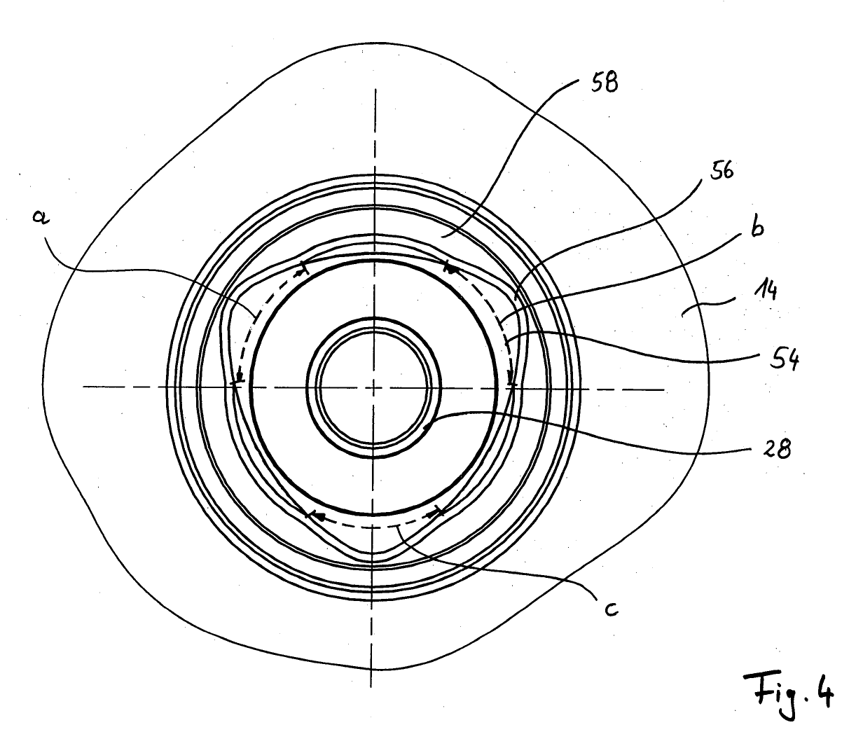

FIG. 4 a side view from the right according to the arrow IV of FIG. 3.

In FIG. 1, a brake pressure generator according to the invention is generally denoted by 10. It comprises a force input element 12, which is connected to a non-illustrated brake pedal. The force input element 12 is introduced by its, in FIG. 1, left end into a housing 14. Rubber bellows 16 ensure a dustproof connection between the housing 14 and the force input element 12. Formed on the end of the housing 14 remote from the force input element 12 is a master brake cylinder 18, in which a pressure piston 20 is accommodated. The pressure piston 20 with the master brake cylinder 18 of the housing 14 encloses a pressure chamber 22, which contains a hydraulic brake fluid. The pressure chamber 22 further contains a spring arrangement 24, which biases the pressure piston 20 into a normal position.

Disposed in the housing 14 between the pressure piston 20 and the force input element 12 is a ball screw 26. It comprises a threaded spindle 28 and a threaded nut 30. The threaded spindle at its, in FIG. 1, right end is designed with an axial bore, in which it accommodates a transmission element 32 and the, in FIG. 1, left end of the force input element 12. The transmission element 32 is used to transmit an input force F, which acts upon the force input element 12, to the threaded spindle 28.

A transmission rim 34 is connected non-rotatably to the threaded nut 30. This transmission rim 34 is supported via a rolling-contact bearing arrangement in the housing 14. The rolling-contact bearing arrangement comprises an axial bearing 36 and a radial bearing 38, wherein the radial bearing 38 is secured by means of a locking ring 40 in the housing 14. The transmission rim 34 at its outer periphery comprises radial gearing 42, which is in working mesh with a likewise radially geared driving gear wheel 44. The driving gear wheel 44 is fitted non-rotatably on an output shaft 46 of an electric drive motor 48. The drive motor 48 is firmly connected to the housing 14.

In an, as such, known manner a plurality of rolling elements 50 are disposed in a cage between the threaded spindle 28 and the threaded nut 30.

The threaded spindle 28 is biased by a restoring spring 52 into the position shown in FIG. 1.

Turning to the, in FIG. 1, right end of the threaded spindle 28, it may be seen that the threaded spindle 28 is connected to a guide sleeve 54, wherein the guide sleeve 54 is seated in a fixed manner on the right end of the threaded spindle 28. The guide sleeve 54 is accommodated in a guide ring 56, which is held in the housing 14 by local edged connections. This may be seen in detail also in FIGS. 2 to 4. The guide ring 56 is manufactured from metal and coated with a friction-reducing plastics material, namely with polytetrafluoroethylene.

FIG. 2 shows, in a perspective view, the ball screw 26 comprising the threaded spindle 28 and the threaded nut 30 as well as the rolling elements 50 disposed therebetween to reduce friction. This figure further shows part of the housing 14. This comprises an integrally moulded necking region 58, which receives the guide ring 56 and to which the guide ring 56 is fixed by edged connections. The necking region 58 as well as the guide ring 56, as FIG. 4 reveals, have a closed undulating profile. The guide ring 56, as already mentioned above, receives the guide sleeve 54 positively in the regions a, b and c, which are indicated by dashed arrows in FIG. 4, and therefore prevents the guide sleeve 54 and the threaded spindle 28 firmly connected thereto from rotating relative to the housing.

As FIG. 4 in particular reveals, the guide sleeve 54, which in cross section is designed with a triangular profile having arc-shaped sides and continuously rounded-off edges, and hence the threaded spindle 28 are supported at three points, namely the regions a, b and c, uniformly distributed over the periphery against the guide ring 56. By virtue of this positive, i.e. snug support in the regions a, b and c, the supporting forces that are to be transmitted for support purposes are introducible into the housing 14 without any risk of jamming phenomena or undesirable lumped loads. Because jamming effects and lumped loads are avoided, secure and reliable as well as low-friction linear guidance and locking against rotation of the threaded spindle 28 are therefore guaranteed.

During operation, a brake pedal actuation is sensed, e.g. by means of a force sensor disposed in the region of the force input element. In accordance with the sensed brake pedal actuation, the electric motor 48 is activated and via the gear wheel 44 drives the transmission rim 34. This sets the threaded nut 30 in rotation. Consequently, the threaded spindle 28, which is guided such as to be locked against rotation, is displaced, in FIG. 1, to the left and accordingly displaces the pressure piston 20. A hydraulic brake pressure is therefore built up in the pressure chamber 22.

Once the brake pedal has been released by the driver, the motor 48 is deactivated. Consequently, the driving gear wheel 44 may rotate freely. Under the action of the restoring spring 52 the entire arrangement may therefore return to its position shown in FIG. 1, wherein the brake pressure in the pressure chamber 22 is reduced.

1. Electromechanical brake pressure generator for a motor vehicle brake system comprising
a force input element, which is connected to a brake pedal;
a housing and a pressure piston displaceable in the housing, wherein the pressure piston with the housing encloses a pressure chamber for generating a hydraulic brake pressure; and
a threaded spindle/threaded nut arrangement, of which one component for displacing the pressure piston is guided linearly relative to the housing by means of an anti-rotation device and of which the other component is settable in rotation in the housing;
wherein the pressure piston is displaceable in accordance with a displacement of the force input element by virtue of the setting in rotation of the component of the threaded spindle/threaded nut arrangement that is settable in rotation in order to generate a hydraulic brake pressure in the pressure chamber;
wherein for forming the anti-rotation device, a region of the linearly guided component of the threaded spindle/threaded nut arrangement is provided with a cylindrical guide profile, which interacts with a complementary profile that is fixed relative to the housing, wherein the area of the guide profile has such a shape that the linearly guided component of the threaded spindle/threaded nut arrangement is supported against the complementary profile during a transmission of supporting forces that is uniformly distributed over the periphery of the cylindrical guide profile.

2. Electromechanical brake pressure generator according to claim 1,
wherein the guide profile has a polygonal area.

3. Electromechanical brake pressure generator according to claim 2,
wherein the guide profile has a substantially triangular area.

4. Electromechanical brake pressure generator according to claim 2,
wherein the side edges of the polygonal area are of an arc-shaped design.

5. Electromechanical brake pressure generator according to claim 2,
characterized in that the corner regions of the polygonal area are continuously rounded.

6. Electromechanical brake pressure generator according to claim 1,
wherein the complementary profile is formed by a guide ring, which positively receives the guide profile at least in sections.

7. Electromechanical brake pressure generator according to claim 6,
wherein the guide ring is accommodated and locked against rotation in the housing.

8. Electromechanical brake pressure generator according to claim 6,
wherein the guide ring is manufactured from a friction-reducing material or is coated with a friction-reducing material.

9. Electromechanical brake pressure generator according to claim 1,
wherein the linearly guided component of the threaded spindle/threaded nut arrangement is formed by the threaded spindle and that the component of the threaded spindle/threaded nut arrangement that is settable in rotation is formed by the threaded nut.

10. Electromechanical brake pressure generator according to claim 1,
wherein the threaded spindle/threaded nut arrangement is formed by a ball screw.

11. Motor vehicle brake system having an electromechanical brake pressure generator according to claim 1.
